(19) United States
(12) Patent Application Publication
(10) Pub. No.: US 2021/0155770 A1
(43) Pub. Date: May 27, 2021

(54) USE OF HYDROGEN PEROXIDE IN SOLID FORM TO MODIFY THE RHEOLOGY OF A THERMOPLASTIC POLYMER WHEN MELTED

(71) Applicant: Arkema France, Colombes (FR)

(72) Inventors: Markus BRANDHORST, Lyon (FR); Isabelle TARTARIN, Lyon (FR)

(21) Appl. No.: 16/756,869

(22) PCT Filed: Nov. 8, 2018
(86) PCT No.: PCT/FR2018/052779

§ 371 Date: Apr. 17, 2020

(30) Foreign Application Priority Data
Nov. 8, 2017 (FR) 1760507

(51) Int. Cl. C08K 3/26; C08F 210/06; C08K 9/12; C08K 5/14; C08K 3/20; C08L 23/08

(52) U.S. Cl. CPC C08K 3/26; C08F 210/06; C08K 9/12; C08K 5/14; C08F 2500/12; C08L 23/08; C08F 2810/10; C08K 2003/262; C08K 3/20

(57) ABSTRACT

The invention relates to the use of at least one hydrogen peroxide in solid form to modify the rheology of a thermoplastic polymer when melted, specifically a polyolefin and particularly a polymer comprising at least one unit from propylene and, more particularly, polypropylene. The invention also relates to a method for modifying the rheology of a thermoplastic polymer when melted, specifically reducing viscosity when melted.

The present invention relates to the use of at least one hydrogen peroxide in solid form for modifing the melt rheology of a thermoplastic polymer, in particular of a polyolefin, in particular of a polymer comprising at least one unit derived from propylene, and more particularly polypropylene.

The invention also relates to a process for modifying the melt rheology, in particular for reducing the melt viscosity, of a thermoplastic polymer as defined above comprising at least one step of mixing at least one hydrogen peroxide in solid form and said polymer.

The invention also relates to the thermoplastic polymer capable of being obtained by the process as defined above.

The present invention also relates to a premix composition comprising at least one hydrogen peroxide in solid form, at least one thermoplastic polymer as defined above and optionally at least one organic peroxide intended to be used in the process according to the invention.

The controlled preparation of various grades of polyolefins, generally carried out following their polymerization, has the advantage of resulting in polymers having molar masses, melt viscosities, densities or else specific molar mass distributions which are adapted to the type of technical application envisaged without harming the quality of the product obtained. Such a preparation is generally carried out using conventional methods, for example an extrusion or injection molding process.

The melt rheology of polyolefins, and in particular their viscosity, can in particular be controlled, during the extrusion or injection-molding step, by adding compounds capable of generating free radicals.

More specifically, the use of compounds capable of generating free radicals, such as organic peroxides, for example dialkyl peroxides, makes it possible to lead to a controlled degradation in the melt state, via chain scission, in particular of the viscosity, of the polyolefins, in particular of the polymers comprising at least one unit derived from propylene, such as polypropylene.

Indeed, polypropylene is a polyolefin that is most often obtained by polymerization of propylene monomers in the presence of catalysts during the Ziegler-Natta reaction (also referred to as Ziegler Natta catalysis), followed by a step of controlled degradation in the presence of dialkyl peroxides that are added, in liquid or solid form, during an extrusion or injection-molding step at temperatures above 180° C. Under these operating conditions, the dialkyl peroxides thus generate free radicals which will have the function of cutting the polypropylene chains by inducing reactions known as beta-scission. Following such reactions, polypropylenes having lower molecular weights will be obtained.

In particular, the controlled degradation of the polypropylene makes it possible to lead to products having in particular a lower molecular weight, a narrower molecular weight distribution, a higher melt flow index (MFI) and also a lower melt viscosity. Such a degradation can be obtained in particular by carrying out a visbreaking process. This visbreaking process consists in controllably carrying out the chain scission in the melt state of a thermoplastic polymer. The polypropylene thus obtained can then be easily processed to manufacture molded articles, films or fibers.

However, the organic peroxides regularly used during the step of controlled degradation of the polyolefins, in particular the polyolefins capable of being obtained by Ziegler-Natta catalysis, have the drawback of generating undesirable volatile organic compounds in high contents within the polyolefins obtained. In other words, the use of organic peroxides results in polyolefins having degraded melt rheological properties which have a residual content of undesirable volatile organic compounds which may be high and detrimental for the intended application.

Furthermore, organic peroxides also have the disadvantage of being very unstable species when they are heated. In fact, in the event of an uncontrolled rise in temperature, certain organic peroxides can undergo exothermic self-accelerating decomposition and risk igniting and/or exploding violently which has the consequence of complicating the transportation thereof to and/or the storage thereof at polyolefin production units, in particular polypropylene production units. In other words, the use of organic peroxides requires special precautions to be put in place when handling them.

In order to overcome these various drawbacks, it has already been proposed in the prior art to use other compounds capable of generating free radicals such as hydrogen peroxide in aqueous solution in order to degrade one or more melt rheological properties of the polyolefins.

In this regard, the scientific article published in the journal Polymer Degradation and Stability in the edition 117 (2015) on pages 97-108 (G. Moad et al) describes a process that makes it possible to increase the melt flow index (MFI), namely therefore to reduce the melt viscosity, of polypropylene in the presence of aqueous hydrogen peroxide. In particular, this document describes an extrusion process in which an aqueous solution of hydrogen peroxide is injected into the extruder in order to reduce the melt viscosity of the polypropylene.

Similarly, patent application DE 1495285 describes the use of aqueous hydrogen peroxide in methanol in order to reduce the melt viscosity of polyolefin, in particular of polypropylene.

However, the use of aqueous hydrogen peroxide also proves to have a certain number of drawbacks.

Specifically, aqueous hydrogen peroxide does not mix properly with polyolefins, which are hydrophobic compounds, in the absence of an additional additive such as a wetting agent or a surfactant. Thus, a heterogeneous product is generally obtained having a low melt flow index (MFI) which is liable to fluctuate significantly during extrusion. In other words, the use of aqueous hydrogen peroxide results in polyolefins having a melt flow index that is generally low and unstable.

To overcome this drawback, a large amount of aqueous hydrogen peroxide is necessary to achieve performance levels, in terms of controlled degradation of the melt rheological properties of the polyolefins, in particular regarding their melt flow index (MFI), which are similar to those obtained with organic peroxides. In other words, a larger amount of aqueous hydrogen peroxide is used to lead to the same results as those obtained with organic peroxides without actually improving the reproducibility of the extrusion process using them.

Furthermore, the injection of aqueous hydrogen peroxide, in particular in large amounts, into the extruder can cause extrusion defects, for example the presence of bubbles of moisture or release of volatile substances, which require the implementation of additional degassing and/or deaeration operations which makes the extrusion more tedious to implement.

Thus one of the objectives of the present invention is to use one or more compounds, capable of effectively modifying one or more melt rheological properties of polymers, which do not have the drawbacks mentioned above.

In other words, there is a real need to provide compounds that are easy to handle and/or prepare, and that are capable of leading to a homogeneous polymer having a lower content of volatile organic compounds than that obtained, under the same conditions, with organic peroxides and one or more melt rheological properties of which have been modified, in particular by reducing their melt viscosity.

In view of the above, the invention more particularly aims to reduce the melt viscosity, that is to say to increase the melt flow index (MFI), of polymers in an effective and stable manner.

One subject of the present invention is therefore in particular the use of at least one hydrogen peroxide in solid form for modifying the melt rheology of a thermoplastic polymer, in particular of a polyolefin.

Hydrogen peroxide in solid form has the advantage of effectively and stably modifying one or more melt rheological properties of thermoplastic polymers, in particular by leading to a high melt flow index (MFI), i.e. a low melt viscosity, capable of remaining stable throughout the extrusion process.

In particular, hydrogen peroxide in solid form makes it possible, under the same conditions, to lead to a higher melt flow index (MFI), i.e. a lower melt viscosity, than hydrogen peroxide in aqueous form.

More particularly, for one same level of melt flow index, hydrogen peroxide in solid form makes it possible to significantly reduce the effective amount of hydrogen peroxide capable of modifying the melt rheological properties of thermoplastic polymers compared to hydrogen peroxide in aqueous form.

Furthermore, the melt flow indices (MFI) obtained with hydrogen peroxide in solid form are stable, in particular more stable than those obtained with aqueous hydrogen peroxide.

In addition, hydrogen peroxide in solid form also has the advantage of leading to a homogeneous polymer comprising a content of volatile organic compounds (VOCs) that is significantly lower than that obtained, under the same conditions, with organic peroxides.

Thus hydrogen peroxide in solid form makes it possible to reduce the residual content of undesirable volatile organic compounds (VOCs) in the polymer, of which one or more melt rheological properties have been modified.

The invention also relates to a process for modifying the melt rheology of a thermoplastic polymer comprising at least one step of mixing at least one hydrogen peroxide in solid form and said polymer.

The process according to the invention makes it possible in particular to modify one or more melt rheological properties of a thermoplastic polymer, in particular by effectively reducing their melt viscosity.

Furthermore, the process according to the invention also makes it possible to increase the melt flow index (MFI) of the thermoplastic polymer.

The process according to the invention also has the advantage of reproducibly modifying one or more melt rheological properties of a thermoplastic polymer.

In particular, the process leads reproducibly to thermoplastic polymers which in particular have low melt viscosities and high melt flow indices, more particularly compared to processes using aqueous hydrogen peroxide.

Thus the process according to the invention makes it possible to effectively control the rheology of thermoplastic polymers, in particular of polyolefins, at the outlet of a polymerization reactor.

Another subject of the invention is a thermoplastic polymer capable of being obtained by the process as defined above.

The thermoplastic polymer capable of being obtained by the process as described above has the advantage of being homogeneous, of having a high and stable melt flow index (MFI) and of comprising a content of undesirable volatile organic compounds (VOC) lower than that contained in the same polymer obtained under the same conditions with an organic peroxide.

Likewise, the present invention relates to a composition comprising at least one hydrogen peroxide in solid form and at least one organic peroxide.

The composition according to the invention is particularly advantageous for reducing the defects which may occur during the process described above while reducing the residual content of undesirable volatile organic compounds in the polymer relative to the use of organic peroxide alone.

The invention also relates to a premix composition comprising:
at least one thermoplastic polymer,
at least one hydrogen peroxide in solid form, and
optionally at least one organic peroxide.

The premix composition according to the invention is used in order to be employed in the process according to the invention in order to modify the melt rheology of a thermoplastic polymer obtained after polymerization and lead to a homogeneous polymer having in particular a lower melt viscosity and a higher melt flow index.

In particular, the premix composition according to the invention is intended to be used in an extruder for modifying the rheological properties of the thermoplastic polymer.

Other characteristics and advantages of the invention will emerge more clearly on reading the following description and examples.

In the following text, and unless indicated otherwise, the limits of a range of values are included in said range.

The expression “at least one” is equivalent to the expression “one or more”.

Use

As indicated above, the invention relates to the use of one or more hydrogen peroxides in solid form for modifying the melt rheology of a thermoplastic polymer.

Preferably, the hydrogen peroxide(s) in solid form is or are used to modify one or more melt rheological properties of a thermoplastic polymer.

In particular, the hydrogen peroxide(s) in solid form is or are used for controllably carrying out chain scission, in the melt state, of a thermoplastic polymer.

The rheological property (properties) of the thermoplastic polymer thus modified is (or are) in particular chosen from the group consisting of the melt flow index (MFI), the melt viscosity, the molecular weight, the molecular weight distribution and the polydispersity index, preferably in order to decrease the melt viscosity of said thermoplastic polymer.

Thus the hydrogen peroxide(s) in solid form is or are in particular used to reduce the molecular weight and the molecular weight distribution of a thermoplastic polymer.

The hydrogen peroxide(s) in solid form is or are in particular used to reduce the polydispersity index of a thermoplastic polymer.

More preferentially, the hydrogen peroxide(s) in solid form is or are used to reduce the melt viscosity of a thermoplastic polymer.

In other words, the hydrogen peroxide(s) in solid form is or are in particular used to increase the melt flow index (MFI) of a thermoplastic polymer.

The melt flow index (MFI) of a thermoplastic polymer is measured in accordance with the methods commonly used to characterize thermoplastic materials making it possible to obtain information on the extrudability and also the shapability of the material, such as those described in standard ASTM D1238, standard NF T51-016 or standard ISO 1133.

The MFI values referred to are determined according to standard ISO 1133 at a temperature of 190° C. and 230° C. under a load of 2.16 kg (units expressed in g/10 min).

Preferably, the hydrogen peroxide(s) in solid form is or are used for modifying the melt rheology of a polyolefin.

The polyolefin is preferably chosen from the group consisting of polymers comprising in their structure at least one unit derived from propylene, that is to say having in their structure at least one unit derived from propylene.

In other words, the polyolefin is preferably chosen from the group consisting of propylene-based polymers.

Thus, preferably, the thermoplastic polymer is a polymer comprising at least one unit derived from propylene.

The polymer comprising at least one unit derived from propylene can be chosen from the group consisting of polypropylene, that is to say a propylene homopolymer, or propylene copolymers comprising in their structure at least 50 mol % of units derived from propylene, that is to say that at least 50 mol % of the copolymer consists of polymerized propylene fragments.

The propylene copolymers further comprise in their structure one or more copolymerizable monomers, in particular one or more ethylenically unsaturated monomers chosen from the group consisting of ethylene, butylene, hexene, octene, vinyl esters and (meth)acrylics.

Thus, preferably, the thermoplastic polymer is chosen from the group consisting of polypropylene and propylene copolymers comprising in their structure at least 50 mol % of units derived from propylene and at least one unit derived from an ethylenically unsaturated monomer other than propylene, preferably chosen from the group consisting of ethylene, butylene, hexene, octene, vinyl esters and (meth)acrylics.

Preferably, the propylene copolymers comprise in their structure from 50 to 90 mol %, more preferably from 60 to 80 mol %, of units derived from propylene, the remainder consisting of at least one unit derived from at least one copolymerizable monomer, in particular one or more ethylenically unsaturated monomers chosen from the group consisting of ethylene, butylene, hexene, octene, vinyl esters and (meth) acrylics.

The thermoplastic polymer is advantageously polypropylene, i.e. a propylene homopolymer, or a propylene copolymer comprising at least 50 mol % of units derived from propylene and at least one unit derived from a comonomer chosen from the group consisting of ethylene, 1-butylene, 1-hexene and 1-octene.

More preferentially, the polymer comprising at least one unit derived from propylene is polypropylene.

According to one embodiment, the invention relates to one or more hydrogen peroxides in solid form for reducing the melt viscosity of a polyolefin.

According to one embodiment, the invention relates to one or more hydrogen peroxides in solid form for reducing the melt viscosity of a polypropylene.

According to the present invention, the hydrogen peroxide used for modifying the melt rheology of the thermoplastic polymer is a product that is solid at room temperature containing at least hydrogen peroxide.

For the purposes of the present invention, ambient temperature is understood to mean a temperature ranging from 10° C. to 30° C., in particular from 15° C. to 25° C.

Hydrogen peroxide is thus a solid product which is dry to the touch and can be in the form of a powder.

Advantageously, the solid hydrogen peroxide is in pulverulent form.

Preferably, the solid hydrogen peroxide may be a solid adduct or a solid material in which aqueous hydrogen peroxide is adsorbed on a solid support.

For the purposes of the present invention, the term adduct denotes the product of an addition reaction between hydrogen peroxide and another molecular entity.

Preferably, the solid hydrogen peroxide is chosen from the group consisting of sodium percarbonate (2Na₂CO₃.3H₂O₂), urea-hydrogen peroxide (H₂O₂—CO(NH₂)₂), hydrogen peroxide adsorbed on a solid support and mixtures thereof.

In particular, the hydrogen peroxide powder can be obtained by precipitation of a hydrogen peroxide adduct, preferably sodium percarbonate or urea-hydrogen peroxide, or by mixing an aqueous solution of hydrogen peroxide and a solid support.

According to one embodiment, the solid hydrogen peroxide is an adduct.

In accordance with this embodiment, the adduct may be derived from the addition reaction between:
hydrogen peroxide (H₂O₂) and sodium carbonate (Na₂CO₃) to form sodium percarbonate, or
hydrogen peroxide (H₂O₂) and urea to form carbamide peroxide (urea-hydrogen peroxide (H₂O₂—CO(NH₂)₂)).

According to another embodiment, the solid hydrogen peroxide is a solid material obtained by mixing an aqueous solution of hydrogen peroxide and a solid support.

The solid support used is capable of adsorbing hydrogen peroxide in liquid form while remaining dry to the touch. Thus the solid material obtained is dry to the touch.

The solid support may be organic or inorganic.

By way of example, superabsorbent polymers, such as those obtained from acrylic acid sold under the name Aquakeep® and produced by SUMITOMOSEIKA CHEMICAL, may be used as an organic support.

Alternatively, the inorganic support may be obtained from various types of silica.

The silicas used are preferably amorphous and may be of precipitated origin or of pyrogenic origin.

The silica of precipitated origin is thus obtained by precipitation, in particular by reaction of a mineral acid with solutions of alkali metal silicates, preferably sodium silicate. In particular, a sulfuric acid solution and a sodium silicate solution are simultaneously added, with stirring, into water. The precipitation of the silica is carried out under alkaline conditions.

The properties of the precipitated silica may be controlled and manipulated as a function of the reaction conditions. Specifically, the duration and the type of stirring, the duration of the precipitation, the speed of addition of the reagents and also their temperature and their concentration, as well as the pH of the reaction medium are all parameters likely to influence the properties of the precipitated silica thus obtained. The formation of a gel is in particular avoided by mixing the solutions described above at a high temperature (for example, a temperature ranging from 85° C. to 95° C.). Conversely, the fact of carrying out the precipitation at a low temperature (for example at a temperature ranging from 20° C. to 30° C.) can lead to the formation of a silica gel.

The white precipitate thus obtained is subsequently filtered, washed and then dried.

The silica of precipitated origin is porous and, consequently, has the ability to be able to absorb liquid. The silica of precipitated origin may be sold under the trade name Sipernat® 500 LS and Sipernat® 22LS by Evonik or under the name Syloid® 244FP by W. R. Grace.

The silica of pyrogenic origin (also called fumed silica) can also be used as an inorganic support. Such a silica has a very different morphology from the silica of precipitated origin.

The silica of pyrogenic origin (or fumed silica), such as those sold under the trade name Aerosil® by Evonik and CAB-O-SIL® by Cabot, is a product characterized by an amorphous structure and a range of primary particle sizes.

Such a silica is of pyrogenic origin due to its production in an oxyhydrogen flame. It consists of microdroplets (primary particles) of amorphous silica which melt to form chain branched three-dimensional aggregates (secondary particles) which are capable of then agglomerating into tertiary particles. The individual microdroplets are essentially non-porous.

Fumed silica is generally obtained by first carrying out a step of continuous flame hydrolysis of a substance such as silicon tetrachloride (SiCl₄) in the presence of hydrogen and oxygen from the air. Thus the formation of silica can be described as being an oxyhydrogen reaction in the presence of water. Specifically, the hydrolysis of silicon tetrachloride with water is carried out in a continuous flame so as to produce silica in a few fractions of a second.

Following this reaction, a mixture of hot gases and silica particles also containing hydrochloric acid is obtained in the form of an aerosol.

The aerosol is then cooled before carrying out a step of separating the gas phase and the solid phase. After separation, the solid phase still contains significant amounts of hydrochloric acid adsorbed on the surface of the silica particles.

A deacidification step is then carried out in order to remove the hydrochloric acid so as to obtain untreated hydrophilic fumed silica.

After this deacidification step, the fumed silica has a high density of free silanol (Si—OH) groups on the surface, giving it an extremely hydrophilic character. Thus the surface of the fumed silica particles is readily wettable in the presence of water. Without being bound by any one theory, given that the primary particles of fumed silica are non-porous, when liquid is added, such a liquid is not adsorbed in the silica particles (as is the case for precipitated silica which is porous) but remains on the surface of the three-dimensional aggregates or chain branched secondary particles which leads to the formation of a large number of agglomerates. Even though the agglomerates are formed of individual aggregates, it can be seen that the morphology of the surface of the aggregates and of the agglomerates is sufficiently complex to retain large amounts of liquid if the latter is capable of wetting the surface.

The surface of hydrophilic fumed silica can be modified by a variety of post-treatments. In this way, the fumed silica can be chemically surface-modified by chemical reaction by converting the silanol (Si—OH) groups into hydrophobic groups. In other words, the density of the free silanol groups is reduced.

The amount of liquid hydrogen peroxide adsorbed on the silica while ultimately forming a powder depends in particular on the type of silica. In general, the weight ratio between the silica and the aqueous hydrogen peroxide varies from 5/95 to 70/30, preferably from 5/95 to 50/50 and more preferentially from 8/92 to 30/70.

The aqueous hydrogen peroxide solution adsorbed on the solid can comprise a hydrogen peroxide content ranging from 5% to 70% by weight, in particular from 35% to 70% by weight, relative to the total weight of the solution.

Preferably, the hydrogen peroxide in solid form is sodium percarbonate (2Na₂CO₃. 3H₂O₂).

According to one embodiment, the invention relates to the use of a hydrogen peroxide powder for modifying one or more rheological properties as defined above of a thermoplastic polymer as defined above.

According to one embodiment, the invention relates to the use of sodium percarbonate for reducing the melt viscosity of a polyolefin, in particular of a polymer comprising at least one unit derived from propylene, in particular polypropylene.

Advantageously, the hydrogen peroxide in solid form can be used in a mixture with one or more organic peroxides as defined below in order to modify the melt rheology of a thermoplastic polymer as defined below.

More advantageously, the sodium percarbonate is used in combination with 2,5-dimethyl-2,5-(di(tert-butylperoxy)hexane for modifying one or more rheological properties as defined above, in particular for reducing the melt viscosity, of a thermoplastic polymer as defined above.

In this case, the use of hydrogen peroxide in solid form also makes it possible to significantly reduce the amount of organic peroxide(s) to be used to effectively modify one or more melt rheological properties of a thermoplastic polymer.

The fact of reducing the amount of organic peroxide(s) is particularly advantageous given the unstable nature of compounds of this type and the precautionary measures to be taken for storing and using it.

In other words, the use of such a mixture makes it possible in particular to result in a thermoplastic polymer having one or more melt rheological properties similar to that (those) obtained with organic peroxide alone while having a smaller amount of volatile organic compounds in its structure.

Preferably, the solid hydrogen peroxide as defined above is used without a water-soluble catalyst, more preferentially without a catalyst.

Preferably, the solid hydrogen peroxide as defined above is used at a temperature ranging from 50° C. to 350° C., and more particularly ranging from 100° C. to 300° C.

Specifically, if the mixing is carried out at a temperature above 350° C., there is a risk of oxidizing and coloring the final product, which is not desirable in the context of the present invention.

Preferably, the use according to the invention is not intended to oxidize the thermoplastic polymer as defined above.

Thus, the present invention relates to the use of at least one hydrogen peroxide in solid form for modifying the melt rheology of a thermoplastic polymer, without increasing its degree of oxidation. Preferably, the thermoplastic polymer obtained has a degree of oxidation of less than 6 mg of oxygen/g of thermoplastic polymer, preferably of less than 5 mg/g, more preferentially of less than 4 mg/g, more preferentially of less than 3 mg/g, more preferentially of less than 2 mg/g, and more preferentially of less than 1 mg/g of thermoplastic polymer.

Process

As indicated above, the processs according to the invention for modifying the melt rheology of the thermoplastic polymer as defined above comprises at least one step of mixing between at least one hydrogen peroxide in solid form as defined above and said polymer.

Preferably, the process according to the invention is a process for modifying one or more melt rheological properties of the thermoplastic polymer as defined above.

In particular, the process according to the invention is a process for controlled chain scission, in the melt state, of the thermoplastic polymer as defined above.

Preferentially, the rheological property (or properties) thus modified of the thermoplastic polymer(s) is (or are) as described above.

More preferentially, the process according to the invention is a process for reducing the melt viscosity of a thermoplastic polymer, in particular of a polyolefin as defined above.

As a variant, the process according to the invention is a process for increasing the fluidity, in particular the melt flow index (MFI), of a thermoplastic polymer as defined above.

According to one embodiment, the process according to the invention is a process for reducing the distribution of the molecular weights of a thermoplastic polymer as defined above.

According to another embodiment, the process according to the invention is a process for reducing the polydispersity index of a thermoplastic polymer as defined above.

In accordance with the present invention, the process is in particular a visbreaking process.

The thermoplastic polymer may be a polyolefin, in particular polypropylene.

In particular, the process according to the invention results in a polymer in which the hydrogen peroxide in solid form represents from 0.001% to 15% by weight, preferably from 0.01% to 10%, more preferentially from 0.02% to 5% by weight, more preferentially still from 0.05% to 2% by weight relative to the weight of the thermoplastic polymer.

Preferably, the active concentration of pure hydrogen peroxide varies from 0.001% to 4.5% by weight, preferentially from 0.005% to 0.6% by weight, relative to the weight of the thermoplastic polymer.

The mixing step of the process according to the invention may further comprise at least one organic peroxide.

Preferably, the organic peroxide has a one-minute half-life temperature of greater than 150° C., more preferentially of greater than 160° C., and more preferentially still of greater than 170° C.

Preferably, the organic peroxide is not a peracid. This is because peracids can cause undesirable odor problems and undesirable acidity in the product obtained by the process according to the invention.

Preferably, the organic peroxide is chosen from the group consisting of cyclic ketone peroxides, dialkyl peroxides, monoperoxycarbonates, polyether poly(tert-butyl peroxycarbonate)s, diperoxyketals, peresters and mixtures thereof, more preferentially the organic peroxide is chosen from the group consisting of cyclic ketone peroxides, dialkyl peroxides and mixtures thereof.

Preferably, the cyclic ketone peroxide is chosen from the group consisting of 3,6,9-triethyl-3,6,9-trimethyl-1,4,7-triperoxonane and 3,3,5,7,7-pentamethyl-1,2,4-trioxepane.

Preferably, the monoperoxycarbonate is chosen from the group consisting of tert-butyl isopropyl monoperoxycarbonate, OO-tert-amyl O-(2-ethylhexyl) monoperoxycarbonate and OO-tert-butyl O-(2-ethylhexyl) peroxycarbonate. Preferably, the diperoxyketal is chosen from the group consisting of 1,1-di (tert-butylperoxy)-3,3,5-trimethylcyclohexane, 1,1-di(tert-butylperoxy)cyclohexane, n-butyl 4,4-di(tert-amylperoxy)valerate, ethyl 3,3-di(tert-butylperoxy)butyrate, 2,2-di (tert-amylperoxy)propane, 3,6,6,9,9-pentamethyl-3-ethoxycarbonylmethyl-1,2,4,5-tetraoxacyclononane, n-butyl 4,4-bis(tert-butylperoxy)valerate and ethyl 3,3-di(tert-amylperoxy)butyrate.

Preferably, the perester is chosen from the group consisting of tert-amyl peroxy-3,5,5 -trimethylhexanoate, tert-butyl amyl peroxy-3,5,5-trimethylhexanoate, tert-butyl peroxyacetate, 2,2-di(tert-amylperoxy)butane and tert-butyl peroxybenzoate,

Preferably, the organic peroxide is a dialkyl peroxide.

The dialkyl peroxide is in the following conventional empirical forms:

R—O—O—R or R—OO—R′—OO—R

The segments R or R′ can consist of aliphatic components, but also optionally of branches bearing aromatic or cyclic functions.

Preferably, the compounds belonging to the family of dialkyl peroxides are chosen from 2,5-dimethyl-2,5-di(tert-butylperoxy)hex-3-yne (Luperox® 130), di-tert-butyl peroxide (Luperox DI), di-tert-amyl peroxide (Luperox ® DTA), 2,5-dimethyl-2,5-(di(trt-butylperoxy)hexane (Luperox ® 101), tert-butyl cumyl peroxide, di(tert-butylperoxyisopropyl)benzene, dicumyl peroxide and mixtures thereof. More preferentially, the dialkyl peroxide corresponds to the 2,5-dimethyl-2,5-di(tert-butylperoxy)hexane sold under the trade name Luperox® 101.

In particular, the organic peroxide used in the process according to the invention represents from 0.001% to 15% by weight of the polymer, preferably represents from 0.01% to 10% by weight, more preferentially from 0.02% to 5% by weight, and more preferentially still from 0.05% to 2% by weight of the polymer.

Said organic peroxide may or may not be adsorbed on the solid support of the hydrogen peroxide. In a particular embodiment, the organic peroxide is not adsorbed on the solid support of the hydrogen peroxide.

The mixing step may also comprise one or more functional additives intended to give the polymer to which the hydrogen peroxide is added particular properties/characteristics.

Thus, as regards the additive, it can be chosen from the group consisting of antioxidants; UV protection agents; processing agents, having the function of improving the final appearance when it is used, such as fatty amides, stearic acid and the salts thereof, ethylenebis(stearamide) or fluoropolymers; antifogging agents; antiblocking agents, such as silica or talc; fillers, such as calcium carbonate, and nanofillers, such as, for example, clays; coupling agents, such as silanes; crosslinking agents, such as peroxides other than those mentioned above; antistatic agents; nucleating agents; pigments; dyes; plasticizers; fluidizers and flame-retardant additives, such as aluminium hydroxide or magnesium hydroxide; lubricants such as waxes, in particular oxidized or non-oxidized polyethylene waxes, esters of fatty acids, salts of fatty acids, ethylene bis(stearamide), etc.

In particular, said additive may be an antioxidant. This antioxidant guards against possible oxidation which is not desirable in the context of the present invention.

Preferably, the process according to the invention is carried out without a water-soluble catalyst, more preferentially is carried out without a catalyst.

In particular, the mixing step of the process according to the invention is carried out for a time sufficient to enable the hydrogen peroxide in solid form to generate free radicals capable of breaking the chains of the thermoplastic polymer.

Preferably, the mixing step of the process according to the invention is carried out for a time ranging from 0.1 to 30 minutes, preferably for a period ranging from 0.5 to 5 minutes.

More preferentially, the step of mixing the polymer and the hydrogen peroxide in solid form takes place at a temperature ranging from 50° C. to 350° C., and more particularly ranging from 100° C. to 300° C. Preferably, the mixing step is a step of extrusion or injection molding of the thermoplastic polymer in the presence of at least one hydrogen peroxide in solid form and said thermoplastic polymer.

More preferentially, the step of extrusion or injection molding of the thermoplastic polymer takes place at a temperature ranging from 50° C. to 350° C., and more particularly ranging from 100° C. to 300° C., in the presence of at least one hydrogen peroxide in solid form and said thermoplastic polymer.

More preferentially still, the mixing step is an extrusion step.

According to one embodiment, the process according to the invention is a process for modifying the melt rheology of a polyolefin, in particular of a polymer comprising at least one unit derived from propylene, in particular polypropylene, comprising at least one step of extrusion or injection molding of the thermoplastic polymer in the presence of at least one hydrogen peroxide in solid form and said thermoplastic polymer.

According to one embodiment, the process according to the invention is a process for modifying the melt rheology of a polyolefin, in particular polypropylene, comprising at least one step of extrusion or injection molding of said polyolefin in the presence of:
at least one hydrogen peroxide in solid form chosen from the group consisting of sodium percarbonate (2Na₂CO₃. 3H₂O₂), urea-hydrogen peroxide (H₂O₂—CO(NH₂)₂, hydrogen peroxide adsorbed on a solid support and mixtures thereof,
at least one organic peroxide chosen from the group consisting of dialkyl peroxides, and
said polyolefin.

More preferentially, the hydrogen peroxide in solid form is sodium percarbonate (2Na₂CO₃. 3H₂O₂).

More preferentially, the dialkyl peroxide is 2,5-dimethyl-2,5-(di(tert-butylperoxy)hexane.

In accordance with this embodiment, the process according to the invention is a process for reducing the melt viscosity of a polyolefin as defined above.

In accordance with this embodiment, the extrusion or injection step preferably takes place at a temperature ranging from 50° C. to 350° C., and more particularly ranging from 100° C. to 300° C.

Preferably, the process according to the invention does not include an oxidation step.

In order to avoid this oxidation step, during the extrusion step, the residence time is preferably less than 5 minutes, preferentially less than 3 minutes, and more preferentially less than 1 minute.

Preferably, the extrusion step is carried out under nitrogen.

Polymer

As indicated above, the invention relates to a thermoplastic polymer capable of being obtained by the process according to the invention.

The thermoplastic polymer according to the invention has the advantage of having a lower residual content of undesirable volatile organic compounds than the thermoplastic polymers obtained under the same conditions with an organic peroxide.

The thermoplastic polymer has the advantage of having a more homogeneous composition than the thermoplastic polymers obtained with an aqueous hydrogen peroxide.

Preferably, the thermoplastic polymer is a polyolefin, in particular a polymer comprising at least one unit derived from propylene.

More preferentially, the thermoplastic polymer is polypropylene.

Preferably, the thermoplastic polymer has a degree of oxidation of less than 6 mg of oxygen/g of thermoplastic polymer, preferably of less than 5 mg/g, more preferentially of less than 4 mg/g, more preferentially of less than 3 mg/g, more preferentially of less than 2 mg/g, and more preferentially of less than 1 mg/g of thermoplastic polymer.

The degree of oxidation can for example be measured by elemental analysis, for example using an Elementar Vario Micro Cube type analyzer.

The thermoplastic polymer capable of being obtained by the process according to the invention is advantageously used to manufacture molded articles, films or fibers.

Composition

As indicated above, the invention relates to a composition comprising at least one hydrogen peroxide in solid form and at least one organic peroxide as defined above.

The composition according to the invention is particularly advantageous for reducing the defects which may occur during the process described above while reducing the content of residuel undesirable volatile organic compounds in the polymer relative to the use of organic peroxide alone.

In particular, the invention relates to a composition comprising at least one hydrogen peroxide in solid form and at least one organic peroxide as defined above, said organic peroxide not being a peracid.

In particular, the composition according to the invention makes it possible to reduce the bubbles and the releases of volatile compounds which may occur during the extrusion of the thermoplastic polymer. In other words, the composition makes it possible to reduce the number of degassing and deaeration operations liable to be carried out during the process according to the invention.

Preferably, the hydrogen peroxide in solid form is chosen from the group consisting of alkali or alkaline-earth metal percarbonates, in particular alkali metal percarbonates.

More preferentially, the hydrogen peroxide in solid form is sodium percarbonate (2Na₂CO₃. 3H₂O₂).

Preferably, the organic peroxide is chosen from the group consisting of cyclic ketone peroxides, dialkyl peroxides, monoperoxycarbonates, polyether poly(tert-butyl peroxycarbonate)s, diperoxyketals, peresters and mixtures thereof, more preferentially the organic peroxide is chosen from the group consisting of cyclic ketone peroxides, dialkyl peroxides and mixtures thereof, more preferentially said organic peroxide is a dialkyl peroxide.

Preferably, the compounds belonging to the family of dialkyl peroxides are chosen from 2,5-dimethyl-2,5-di(tert-butylperoxy)hex-3-yne (Luperox® 130), di-tert-butyl peroxide (Luperox DI), di-tert-amyl peroxide (Luperox ® DTA), 2,5-dimethyl-2,5-(di(tert-butylperoxy)hexane (Luperox® 101), tert-butyl cumyl peroxide, di(tert-butylperoxyisopropyl)benzene, dicumyl peroxide and mixtures thereof.

More preferentially, the dialkyl peroxide corresponds to the 2,5-dimethyl-2,5-di(tert-butylperoxy)hexane sold under the trade name Luperox® 101.

According to one embodiment, the composition comprises:
at least one hydrogen peroxide in solid form chosen from the group consisting of alkali or alkaline-earth metal percarbonates, in particular alkali metal percarbonates,
at least one organic peroxide chosen from dialkyl peroxides.

Premix Composition

As indicated above, the invention also relates to a premix composition comprising at least one thermoplastic polymer, at least one hydrogen peroxide in solid form and optionally at least one organic peroxide as defined above.

Preferably, said premix does not comprise a water-soluble catalyst, more preferentially does not contain a catalyst.

Specifically, the use of a catalyst risks leading to too rapid a reaction and to a colored final product, which is not desirable in the context of the present invention.

For the purposes of the present invention, the term “premix” is understood to mean the composition intended to be used by the process according to the invention.

In other words, the premix composition comprises a thermoplastic polymer, the melt rheological properties of which have not yet been modified following the presence of the hydrogen peroxide in solid form.

In particular, the premix composition comprises a thermoplastic polymer having a lower melt flow index than the thermoplastic polymer obtained by the process according to the invention, that is to say after having been mixed with hydrogen peroxide in solid form.

The premix composition is in particular intended to be used in an extruder to yield a polymer according to the invention.

Preferentially, the premix composition comprises at least one organic peroxide as defined above.

Preferably, the premix composition comprises:
at least one thermoplastic polymer chosen from the group consisting of polyolefins:
at least one hydrogen peroxide in solid form chosen from the group consisting of sodium percarbonate (2Na₂CO₃.3H₂O₂), urea-hydrogen peroxide (H₂O₂—CO(NH₂)₂), hydrogen peroxide adsorbed on a solid support and mixtures thereof,
at least one organic peroxide chosen from dialkyl peroxides.

Preferably, the premix composition comprises:
at least one thermoplastic polymer chosen from the group consisting of polymers comprising at least one unit derived from propylene, in particular polypropylene,
sodium percarbonate (2Na₂CO₃.3H₂O₂),
at least one organic peroxide chosen from dialkyl peroxides.

The examples that follow serve to illustrate the invention without, however, being limiting in nature.

### EXAMPLES

### Example of Preparation of the Polymer Compositions

In the examples below, various additives were tested in order to modify the melt rheology, in particular by reducing the melt viscosity, of polypropylene (PP).

The polymer compositions, described below, were thus produced by mixing polypropylene (PP) with an additive chosen from:
an organic peroxide (95% pure 2,5-dimethyl-2,5-di(tert-butylperoxy)hexane sold under the trade name Luperox® 101 by Arkema),
hydrogen peroxide in liquid form (aqueous 35% by weight hydrogen peroxide solution sold under the name Albone® 35 by ARKEMA),
sodium percarbonate (sold under the trade name ALDRICH and having an equivalent of hydrogen peroxide of 28.5% by weight),
a mixture of these additives.

The various compositions are prepared in a powder mixer (Caccia CP0010G) at a temperature not exceeding 45° C. at a mixing speed of 2300±200 rpm for a time of 5 to 10 minutes.

The additive concentrations are given in ppm for the organic peroxide or as a weight percentage of pure hydrogen peroxide, or as a percentage of sodium percarbonate (with the equivalent of pure hydrogen peroxide as a weight percentage) relative to the polypropylene.

A process for visbreaking the compositions, described below, is then carried out.

After mixing, the powder obtained is then extruded in the form of granules on a counter-rotating twin-screw extruder of the Brabender KDSE type with a material temperature at the die of 230° C. and a throughput of 7 kg/h.

Melt Flow Index (MFI) Test

The melt flow index (MFI) is measured according to standard ISO 1133 at a temperature of 190° C. under a load of 2160 grams. The die has a length of 8 mm and an internal diameter of 2.095 mm

The temperature for carrying out the test at 190° C. was supplemented in the results tables by a measurement at a temperature of 230° C. (the other test conditions remaining identical).

The higher the melt flow index (MFI), the lower the melt viscosity.

### Example 1

The melt flow index (MFI) was determined for the following compositions at a temperature of 190° C. and 230° C. in accordance with standard ISO 1133.

The results are grouped together in the table below:

TABLE 1
Comparison of the melt flow indices with
hydrogen peroxide or organic peroxide.

| | | MFI | MFI |
|---|---|---|---|
| | | (g/10 min) | (g/10 min) |
| Compositions | | 190° C. | 230° C. |
| 1 | PP alone | 0.9 | 2 |
| 2 | PP + 507 ppm Luperox ® 101 | 7 ± 2 | 19 ± 3 |
| 3 | PP + 1% Albone ® 35 | 2 ± 3 | 21 ± 7 |
| | (0.35% hydrogen peroxide) | | |
| 4 | PP + 3% Albone ® 35 | 5 ± 3 | 17 ± 7 |
| | (1.05% hydrogen peroxide) | | |

During the extrusion of compositions 3 and 4, phenomena of bubbles and released gases were observed and also an extrudability irregularity (unstable hopper feeding).

Results—Discussion

It is found that a large amount of aqueous hydrogen peroxide is necessary to achieve the same performance level, measured by the MFI value of the polypropylene, as in the presence of the organic peroxide.

Furthermore, it is observed that the melt index fluctuates significantly with the aqueous hydrogen peroxide. This phenomenon is due to the irregularity in feeding the polypropylene in the presence of aqueous hydrogen peroxide.

### Example 2

The melt flow index (MFI) was determined for the following compositions at a temperature of 190° C. and 230° C. in accordance with standard ISO 1133.

The results are grouped together in the table below:

TABLE 2
Comparison of the hot melt flow indices with organic peroxide
alone or in the presence of sodium percarbonate.

| | | MFI | MFI |
|---|---|---|---|
| | | (g/10 min) | (g/10 min) |
| Compositions | | 190° C. | 230° C. |
| 5 | PP alone | 0.9 | 2 |
| 6 | PP + 507 ppm Luperox ® 101 | 7 ± 2 | 19 ± 3 |
| 7 | PP + 1013 ppm Luperox ® 101 | 14 ± 2 | 42 ± 3 |
| 8 | PP + 507 ppm Luperox ® 101 + | 10 ± 2 | 32 ± 3 |
| | 0.2% sodium percarbonate | | |
| | (+0.057% hydrogen peroxide) | | |
| 9 | PP + 507 ppm Luperox ® 101 + | 13 ± 2 | 45 ± 3 |
| | 0.4% sodium percarbonate | | |
| | (+0.114% hydrogen peroxide) | | |
| 10 | PP + 1.2% sodium percarbonate | 14 ± 2 | 81 ± 3 |
| | (+0.34% hydrogen peroxide) | | |

By comparing the melt flow indices (MFI) of compositions 10 and 3, it is found that sodium percarbonate is more effective than aqueous hydrogen peroxide.

Indeed, composition 10 has a significantly higher and more stable melt flow index (MFI) than composition 3 at a temperature of 190° C. and 230° C. Consequently, composition 10 also has a lower melt viscosity than composition 3 at these temperatures.

Furthermore, composition 10 has a melt flow index (MFI) that is identical to composition 7 at a temperature of 190° C. and higher at a temperature of 230° C.

It also results from table 2 that the MFI measurements have the same reproducibility whether in the presence of organic peroxide alone or in the presence of a mixture of organic peroxide and sodium percarbonate.

Composition 9 has a melt flow index similar to composition 7 using half the organic peroxide which was replaced by an amount of solid hydrogen peroxide in the form of sodium percarbonate much lower than the amount required in the example 10.

Thus the use of sodium percarbonate makes it possible to reduce the amount of organic peroxide to be used to obtain a thermoplastic polymer having a similar viscosity.

Furthermore, the mixture of organic peroxide and sodium percarbonate has the advantage of reducing bubbles in the extruded polypropylene, which makes it possible to minimize the number of degassing operations during the extrusion.

### Example 3

The amount of volatile organic compounds (in μgC/g) in the following compositions was determined after the visbreaking process.

The content of volatile organic compounds was measured under the analytical conditions used for GC/MS and GC/FID analyses and correspond to those described in detail in standard VDA 277.

The chromatographic conditions used are as follows:
Column: ZB-WAX plus, 30 m×0.25 mm, 0.25 μm
Temperature programming: 50° C. (3 minutes) then 12° C./min up to a temperature of 200° C. (19.5 min)
Carrier gas (helium) flow rate: 1 ml/min
Split: 20 ml/min

An amount of 2.6 grams of each sample is placed in a headspace type sampling vial which is then crimped. The samples are then heated for a period of 5 hours at a temperature of 120° C.

The headspaces of the samples are drawn off then analyzed by GC/MS or GC/FID. The analyses are carried out twice for each sample.

The results are grouped together in the table below:

TABLE 3
Measurements of the volatile matter according to VDA 277

| | Volatiles |
|---|---|
| Compositions | (μgC/g) |

| | | |
|---|---|---|
| 5 | PP alone | 110 |
| 6 | PP + 507 ppm Luperox ® 101 | 320 |
| 7 | PP+ 1013 ppm Luperox ® 101 | 475 |
| 8 | PP + 507 ppm Luperox ® 101 + | 290 |
| | 0.2% sodium percarbonate | |
| | (+0.057% hydrogen peroxide) | |
| 9 | PP + 507 ppm Luperox ® 101 + | 280 |
| | 0.4% sodium percarbonate | |
| | (+0.114% hydrogen peroxide) | |
| 10 | PP + 1.2% sodium percarbonate | 135 |
| | (+0.34% hydrogen peroxide) | |

Composition 9 has a similar melt flow index to composition 7 using half the organic peroxide and also has the advantage of generating a significantly lower volatile matter content.

The results show that the composition according to the invention makes it possible both to increase the melt flow index at temperatures of 190° C. and 230° C. while significantly reducing the content of residual volatile organic compounds in the polypropylene.

For an identical melt flow index level, the composition of the invention also makes it possible to considerably reduce the amount of hydrogen peroxide of use compared to a composition comprising only aqueous hydrogen peroxide.

1-20. (canceled)

21. A process for modifying the melt rheology of a thermoplastic polymer comprising at least one step of mixing said polymer and hydrogen peroxide in solid form.

22. The process of claim 21, wherein modifying the melt rheology of the thermoplastic polymer comprises modifying one or more melt rheological properties of the thermoplastic polymer.

23. The process of claim 22, wherein the one or more melt rheological properties are chosen from the group consisting of the melt flow index (MFI), the melt viscosity, the molecular weight, the molecular weight distribution and the polydispersity index.

24. The process of claim 21, wherein the thermoplastic polymer is a polymer comprising at least one unit derived from propylene.

25. The process of claim 21, wherein the thermoplastic polymer is chosen from the group consisting of polypropylene and propylene copolymers comprising in their structure at least 50 mol % of units derived from propylene and at least one unit derived from an ethylenically unsaturated monomer other than propylene.

26. The process of claim 21, wherein the thermoplastic polymer is polypropylene.

27. The process of claim 21, wherein the hydrogen peroxide in solid form is chosen from the group consisting of sodium percarbonate (2Na₂CO₃.3H₂O₂), urea-hydrogen peroxide (H₂O₂—CO(NH₂)₂), hydrogen peroxide adsorbed on a solid support and mixtures thereof.

28. The process of claim 21, wherein the hydrogen peroxide in solid form is sodium percarbonate (2Na₂CO₃.3H₂O₂).

29. The process of claim 21, wherein the solid hydrogen peroxide is used without a water-soluble catalyst.

30. The process of claim 21, wherein the solid hydrogen peroxide is used at a temperature ranging from 50° C. to 350° C.

31. The process as claimed in claim 21 for visbreaking the thermoplastic polymer.

32. The process as claimed in claim 21, wherein the hydrogen peroxide in solid form represents from 0.001% to 15% by weight of the thermoplastic polymer.

33. The process as claimed in claim 21, wherein the mixing step further comprises at least one organic peroxide.

34. The process as claimed in claim 33, wherein the at least one organic peroxide is a dialkyl peroxide and the dialkyl peroxide is chosen from the group consisting of 2,5-dimethyl-2,5-di(tert-butylperoxy)hex-3-yne, di-tert-butyl peroxide, di-tert-amyl peroxide, 2,5-dimethyl-2,5-di(tert-butylperoxy)hexane, tert-butyl cumyl peroxide, di(tert-butylperoxyisopropyl)benzene, dicumyl peroxide and mixtures thereof.

35. The process as claimed in claim 33, wherein the organic peroxide represents from 0.001% to 15% by weight of the thermoplastic polymer.

36. The process as claimed in claim 21, wherein the mixing step is an extrusion step.

37. A composition comprising at least one hydrogen peroxide in solid form and at least one organic peroxide.

38. A premix composition comprising:
at least one thermoplastic polymer,
at least one hydrogen peroxide in solid form, and
optionally at least one organic peroxide.
